(19) United States
(12) Patent Application Publication
(10) Pub. No.: US 2002/0188828 A1
(43) Pub. Date: Dec. 12, 2002

(54) Low power consumption super scalar processor

(76) Inventor: Hideki Sugimoto, Tokyo (JP)

Correspondence Address: McGinn & Gibb, PLLC, Suite 200, 8321 Old Courthouse Road, Vienna, VA, 22182-3817, US

(21) Appl. No.: 10/153,610

(22) Filed: May 24, 2002

(30) Foreign Application Priority Data
Jun. 6, 2001 (JP) 2001-171003

(51) Int. Cl. G06F 9/30

(52) U.S. Cl. 712/215

(57) ABSTRACT

A super scalar processor includes execution units for data processing on integers, an execution unit for multiplication, an execution unit for data loading/storing and an electric power and clock controller for supplying electric power and a clock signal to them, and one of the execution units for data processing on integers includes an emulator for emulating instruction codes to be executed by the execution unit for multiplication to instruction codes thereto; while the execution unit for multiplication is powered down or off, an instruction analyzing and distributing unit changes the issuance of the instruction codes to the execution unit, and the instruction codes are emulated so as to achieve the given jobs; when an instruction code makes the execution unit for multiplication recovered from the idling state, the execution unit becomes enable after a time lug automatically given thereto so that the super scalar processor is improved in operability.

### FIELD OF THE INVENTION

This invention relates to a super scalar processing technology and, more particularly, to a super scalar processor for executing plural instruction groups with plural execution units.

### DESCRIPTION OF THE RELATED ART

The super scalar processor is developed for speedup of the data processing. The super scalar processor includes plural execution units, and the plural execution units are physically isolated from one another. A series of instruction codes contains instruction loops. The instruction loop is expressed by plural instruction codes. An instruction cache register and/or a main program memory successively supplies the instruction codes to the super scalar processor, and are accumulated in the super scalar processor. The super scalar processor examines the plural instruction codes of the instruction loop to see whether the instructions are dependent on or independent of one another. If the instructions are independent of one another, the instruction codes are to be executed in parallel. Then, the instruction codes are selectively distributed to the plural execution units, and are concurrently executed. The super scalar processor achieves the job through the parallel processing with the plural execution units This results in enhancement of the throughput and, accordingly, speedup of the execution

FIG. 1 shows a typical example of the super scalar processor. The prior art super scalar processor includes an instruction buffer unit 11, an instruction analyzing and distributing unit 21 and four execution units 31, 32, 33 and 34. Though not shown in FIG. 1, a main program memory and an instruction cache memory are connected to the instruction buffer unit 11. Instruction codes are successively supplied from the main program memory and/or the instruction cache memory to the instruction buffer unit 11, and are accumulated in the instruction buffer unit 11. There are plural instruction loops. The instruction buffer unit 11 is connected to the instruction analyzing and distributing unit 21, and the instruction codes are transferred to the instruction analyzing and distributing unit 21.

The instruction analyzing and distributing unit 21 analyzes each of the instruction loops to see whether or not the instructions are dependent on one another. When the instructions are independent of one another, the instruction analyzing and distributing unit 21 assigns the instruction codes to the execution units 31, 32, 33 and 34.

The instruction analyzing and distributing unit 21 is connected in parallel to the execution units 31, 32, 33 and 34. The execution units 31, 32, 33 and 34 are independent of one another from the viewpoint of hardware, and are implemented by high-speed executing circuits. The execution units 31 and 32 are prepared for data processing on integers, and multiplication is carried out by the execution unit 33. The execution unit 34 is prepared for loading/storing. The data processing carried out by the execution unit 31 and the data processing carried out by the execution unit 32 are referred to as “integer processing 1” and “integer processing 2”, respectively.

The prior art super scalar processor behaves as follows. The main program memory and/or the program cache memory successively supplies instruction codes to the instruction buffer unit 11. The instruction codes are not executed in order of arrival. The instruction analyzing and distributing unit 21 analyzes the instruction codes of each instruction loop to see whether or not the instructions are dependent on one another. When the instruction codes of the loop are independent of one another, the instruction analyzing and distributing unit 21 selectively assigns the instruction codes to the execution units 31, 32, 33 and 34, and issues the instructions to the four execution units 31, 32, 33 and 34. The instructions independent of one another are executed in parallel by the execution units 31, 32, 33 and 34 so that the prior art super scalar processor achieves the job at high speed.

A problem is encountered in the prior art super scalar processor in a large amount of power consumption. This is because of the fact that the prior art super scalar processor keeps the four execution units 31, 32, 33 and 34 ready for execution at all times. Even when any instruction is not assigned to certain execution unit or units, the electric power and system clock are supplied to the certain execution unit or units, and the electric power is continuously consumed therein. Thus, there is a trade-of between the high speed execution and the power consumption.

A countermeasure has been proposed in Japanese Patent Application laid-open No. 8-190162. The invention disclosed in the Japanese Patent Application laid-open is entitled as “Microprocessor Having Power Consumption Controlling Capability”. A power control register is incorporated in the prior art microprocessor. The power control register has plural fields, which are respectively corresponding to the other function units of the prior art microprocessor for varying the electric power consumed therein. When a certain instruction code is executed, a corresponding control data code is transferred to the power control register, and the power control register controls the power supply unit for saving the power consumption of the other functional units depending upon the bit string of the control data code. Thus, the power consumption of the prior art microprocessor is controllable through the software.

The prior art power controlling technology may be preferable to the microprocessor. However, the prior art power controlling technology has poor affinity for controlling the power voltage and clock frequency in the super scalar processor. The reason why the prior art power controlling technology is hardly applied to the super scalar processor is that the transit time of the power voltage is much longer than the instruction time of the super scalar processor. Moreover, the clock frequency is to be increased after reaching the power voltage to the high level. Assuming now that the prior art power controlling technology is employed in the super scalar processor in spite of the problems, the software engineer is to insert the instruction code for the power saving earlier than a group of instruction codes permitting an execution unit to enter the idling state by the difference between the transit time and the instruction time. However, it is rare to permit an execution unit to be idle during the execution of the group of instruction codes longer than the transit time. Moreover, while the execution unit is standing idle, the execution unit can not respond to any instruction code, but the power consumption is minimized. This results in that the software engineer tends to hesitate to insert the instruction code for the power saving. In other words, even if the prior art power controlling technology is employed in the super scalar processor, the power saving capability is less beneficial to the users, and the substantial power saving is hardly achieved.

In order to make the prior art power saving technology beneficial to the users of the super scalar processor, it is necessary to specify certain groups of instructions which permits the scalar processor to save the power consumption, and an emulation program or a compiler is to be developed for replacing the certain groups of instructions to other groups of instructions to be executed by another execution unit. Thus, a problem inherent in the super scalar processor with the prior art power saving technology is a large amount of development cost of the emulation program/compiler. Even though the emulation program is developed, the emulator is not available for other groups of instructions, which are too short to switch the power voltage, so that the power consumption is not drastically reduced.

### SUMMARY OF THE INVENTION

It is therefore an important object of the present invention to provide a super scalar processor, which is reduced in power consumption without the development of an emulation program/compiler.

In accordance with one aspect of the present invention, there is provided a super scalar processor comprising a plurality of execution units supplied with a power voltage and a clock signal for executing instructions in parallel, an instruction analyzing and distributing unit connected to the plurality of execution units, analyzing instructions to see whether or not the instructions are dependent on one another and selectively issuing the instructions to the plurality of execution units when the instructions are independent of one another, at least one of the plurality of execution units executing a first sort of instructions so as to produce a control signal representative of values of the power voltage to be respectively supplied to the plurality of execution units and values of the frequency of the clock signal to be respectively supplied to the plurality of execution units, and a source of power voltage and clock signal connected between the aforesaid at least one of the plurality of execution units and the plurality of execution units and responsive to the control signal so as to regulate the power voltage and the clock signal to the values of the power voltage and the values of the clock signal indicated by the control signal, and the instruction analyzing and distributing unit assigns an instruction to be executed by one of the plurality of execution units to another of the plurality of execution units when the source of power voltage and clock signal changes at least one of the power voltage and the clock signal from a value to be supplied to the aforesaid one of the plurality of execution units in enable state to another value different from the value.

### BRIEF DESCRIPTION OF THE DRAWINGS

The features and advantages of the super scalar processor will be more clearly understood from the following description taken in conjunction with the accompanying drawings, in which

FIG. 1 a functional block diagram showing the circuit configuration of the prior art super scalar processor,

FIG. 2 is a functional block diagram showing the circuit configuration of a super scalar processor according to the present invention,

FIG. 3 is a timing chart showing the behavior of the super scalar processor, and

FIG. 4 is a functional block diagram showing the circuit configuration of another super scalar processor according to the present invention.

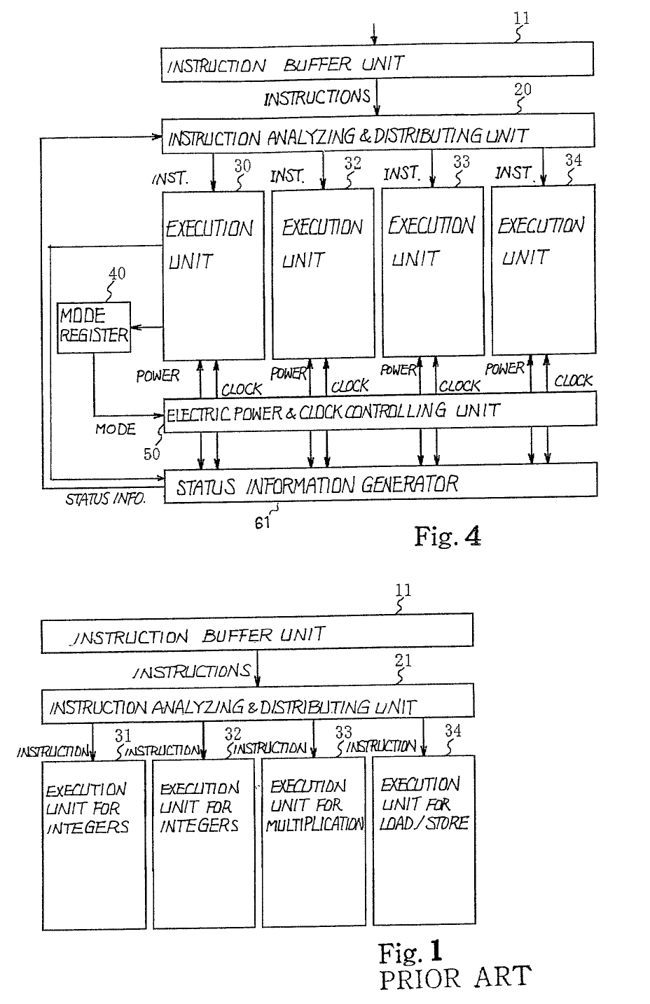

### DESCRIPTION OF THE PREFERRED EMBODIMENTS

First Embodiment

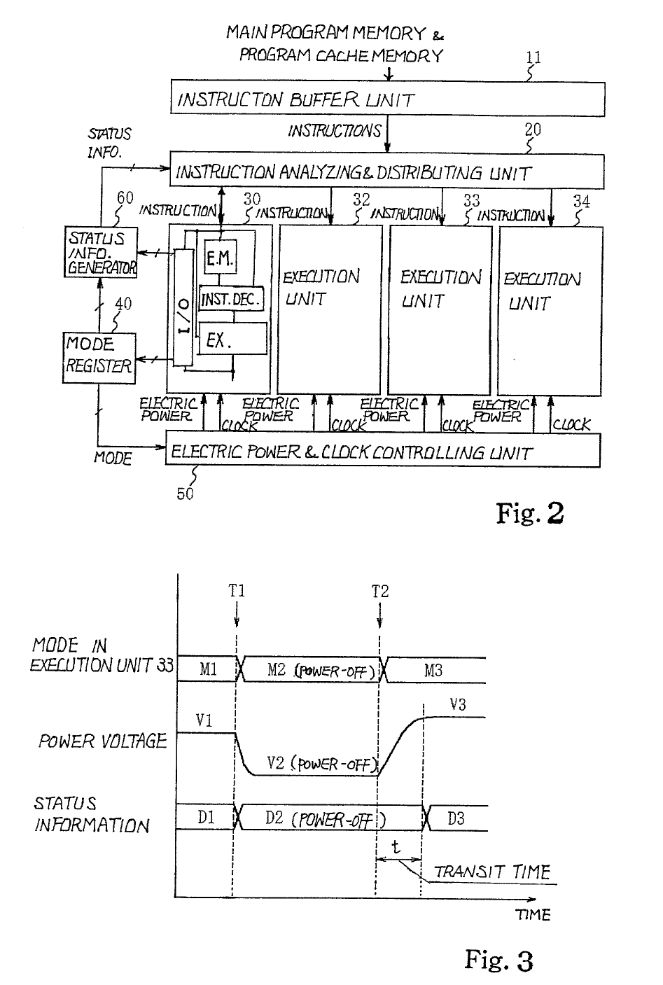

Referring to FIG. 2 of the drawings, a super scalar processor implementing the present invention comprises an instruction buffer unit 11, an instruction analyzing and distributing unit 20, four execution units 30/32/33/34, an electric power and clock controlling unit 50, a mode register 40 and a status information generator 60. The super scalar processor is operative selectively in four modes of operation. A power voltage and a clock frequency are differently defined in the four modes for the four execution units 30/32/33/34, and status information is representative of the power voltage and the clock frequency.

The instruction buffer unit 11 is connected to a main program memory and/or a program cache memory (not shown), and successively fetches instruction codes from the main program memory and/or the program cache memory. The instruction codes are accumulated in the instruction buffer unit 11 as similar to that of the prior art super scalar processor.

The instruction analyzing and distributing unit 20 is connected at the signal input ports thereof to the instruction buffer unit 11 and the status information generator 60 and at the signal output ports thereof to the four execution units 30/32/33/34 in parallel. The instruction analyzing and distributing unit 20 checks the instruction codes of each instruction loop to see whether or not the instructions are dependent on one another, and selectively assigns the instruction codes to the execution units 30/32/33/34. When the status information indicates that all the execution units 30/32/33/34 are available for data processing, the instruction analyzing and distributing unit 20 selectively assigns the instruction codes to the four execution units 30/32/33/34, and the instructions are executed in parallel so as to achieve high-speed data processing. However, if the status information is indicative of power-off state in one of the execution unit 33, the instruction analyzing and distributing unit 20 changes the job assignment, and supplies the instructions to another execution unit 30. The jobs to be achieved by the instructions are the integer processing 1, integer processing 2, multiplication, data loading/storing and a mode change. The integer processing 1, integer processing 2, multiplication and data loading/storing are similar to those achieved by the prior art super scalar processor. The mode change will be described hereinafter in detail.

The four execution units 30/32/33/34 are connected at the signal input ports thereof to the instruction analyzing and distributing unit 20 and the electric power and clock controlling unit 50. Though not shown in the drawings, at least a power supply unit, a potential transformer, a clock generator and switching circuits are incorporated in the electric power and clock controlling unit 50. The power voltage is selectively supplied from the output nodes thereof through the switching circuit to the execution units 30/32/33/34, and a clock signal is supplied from the clock generator through the switching circuit to the execution units 30/32/33/34. With the power voltage, the execution units 30/32/33/34 is responsive to the clock signal so as to execute the given instructions.

The execution unit 30 is prepared for emulation and the integer processing 1. The other execution units 32/33/34 are corresponding to the execution units 32/33/34 of the prior art super scalar processor, and are prepared for the integer processing 2, multiplication and load/store. For this reason, no further description on the execution units 32/33/34 is incorporated hereinbelow.

The execution unit 30 includes at least an emulator E.M., an instruction decoder INST. DEC., an execution unit EX. and an input and output unit I/O. The execution unit EX. can carry out the integer processing 1 and other control sequence such as a branching. Although the execution unit EX. carries out the integer processing 1 at high speed through circuits designed for the integer processing 1, the execution unit EX. does not have any circuits designed for the multiplication. For this reason, the instruction codes for the multiplication is emulated to other instruction codes for controlling the circuits designed for the integer processing 1. This means that the multiplication through the execution unit 30 is not so fast as the multiplication through the execution unit 33. However, the circuits of the execution unit E.X. are smaller and simpler than the circuits of the execution unit 33, and the power consumption is less than that of the execution unit 33.

The status information is assumed to indicate the power-off state of the execution unit 33. The instruction analyzing and distributing unit 20 assigns a group of instructions for the multiplication to the execution unit 30 instead of the execution unit 33. The instructions are transferred from the instruction analyzing and distributing unit 20 to the emulator E.M., and are emulated to another group of instructions. The instructions of another group are successively supplied to the instruction decoder INST. DEC., and the execution unit E.X. is controlled with the decoded signals for the multiplication.

When the status information is indicative of the power-on state of the execution unit 33, the instruction analyzing and distributing unit 20 supplies the group of instructions for the multiplication to the execution unit 33, and a group of instructions for the integer processing 1 to the execution unit 30. The instructions for the multiplication are executed through the hardware at high speed, and the instructions for the multiplication are also executed through the hardware at high speed.

When an instruction code requests the mode change, the instruction code is decoded by the instruction decoder, and the execution unit E.X. produces a control code representative of the status information and a control code representative of the potential levels and the clock signal to be supplied to the individual execution units 30, 32, 33 and 34. The execution unit E.X. supplies the control codes through the input/output unit I/O to the mode register 40 and the status information generator 60.

When an instruction code requests the execution unit 30 to execute a certain job hardly achieved, the emulator E.M. interprets the instruction to be a branch instruction. The certain job requires an emulation time longer than the ascent transit time of the power voltage. A job on a transcendental function of floating point numbers is an example of the certain job. The execution unit 30 reports the unexecuted job to the instruction analyzing and distributing unit 20 through the branch. The instruction analyzing and distributing unit 20 waits until the execution unit 33 is recovered to the enable state, and requests the execution unit 33 to achieve the job.

The mode register 40 includes a data register. Upon completion of the job for the mode change, the control code is transferred from the execution unit 30 to the register, i.e., the mode register 40, and is stored therein. The control code is representative of the modes of operation to be established in the four execution units 30, 32, 33 and 34. The power voltage and the clock frequency are defined in each mode. The mode register 40 instructs the electric power and clock controlling unit 50 to change or maintain the modes presently established in the execution units 30, 32, 33 and 34.

The electric power and clock controlling unit 50 is prepared for the power voltage control and the clock frequency control. When the electric power and clock controlling unit 50 is instructed to change the mode established in one of the execution units 30/32/33/34 from present one to another, control signals are supplied from the mode register 40 to the electric power and clock controlling unit 50, and the power voltage and the clock frequency are changed to respective values defined in the new mode. The execution units 30 and 34 are the most fundamental units of all. Although reduction in power voltage and clock frequency is allowed, the execution units 30 and 34 are to be prohibited from the power-off and stoppage of the clock supply. For this reason, the electric power and clock controlling unit 50 includes a circuitry, which guarantees a certain power voltage and a clock frequency for the execution units 30 and 34. Thus, the execution units 30/34 are prohibited from the frozen state.

The status information generator 60 is connected at the signal input ports to the execution unit 30 and the mode register 40 and at the signal output port to the instruction analyzing and distributing unit 20. The status information generator 60 includes latch circuits and timers. The mode register 40 supplies the control signals representative of the modes of operation to be established in the execution units 30, 32, 33 and 34. The delay time periods are equal to the transmit time periods “t” from the current modes to new modes, and are determined by the execution unit 30 through the execution of the instruction code for the mode change. Control signals representative of the delay times are supplied from the execution unit 30 to the status information generator 60, and the timers start to decrement the delay times. When the timers reach zero, the delay times are expired so that the timers supply latch control signals to the latch circuits. Then, the control signals, which are representative of the modes to be established in the execution units 30, 32, 33 and 34, are stored in the latch circuits, and the pieces of status information are supplied to the instruction analyzing and distributing unit 20.

The delay circuits may be implemented by pulse generating circuits. In this instance, when the execution unit 30 supplies the control signals to the status information generator 60, the pulse generators change the latch control signals to a certain level. The pulse generators keep the latch control signals at the certain level until the delay times are expired. When the delay times are expired, the pulse generators recover the latch control signals from the certain level to another level. Then, the latch circuits are responsive to the transition from the certain level to anther level so as to store the pieces of status information.

FIG. 3 illustrates the behavior of the super scalar processor at the mode change for the execution unit 33. Assuming now that the execution unit 33 is operating in mode M1, the status information generator 60 maintains the piece of status information D1 representative of the active state with the power voltage V1 to the instruction analyzing and distributing unit 20, and the electric power and clock controlling unit 50 supplies the power voltage V1 and the clock signal at a certain frequency to the execution unit 33.

The instruction analyzing and distributing unit 20 analyzes instructions of a loop, and issues the instruction code for mode change to the execution unit 30. The execution unit 30 executes the instruction code at time T1. The execution unit 30 supplies the control signal representative of the change of power voltage from V1 to V2 to the mode register and the control signal representative of the transit time t of zero to the status information generator 60. The electric power and clock controlling unit 50 changes the power voltage from V1 to V2, and the execution unit 33 is not powered. The mode register 40 supplies the piece of status information D2 representative of the power-off state to the status information generator 60, and the piece of status information D2 is immediately latched by the status information generator 60, because the transit time t is zero.

The execution unit 33 stands idle from time T1 to time T2, and the instruction analyzing and distributing unit 20 analyzes the instructions of each loop stored in the instruction buffer unit 11. When the instruction analyzing and distributing unit 20 finds an instruction code or instruction codes to be executed by the execution unit 33, the instruction analyzing and distributing unit 20 checks the status information to see whether or not the execution unit 33 is presently available for the jobs. The status information generator 60 continuously supplies the piece of status information D2 to the instruction analyzing and distributing unit 20 between time T1 and time T2. For this reason, the answer is given negative, and the instruction analyzing and distributing unit 20 issues the instructions to the execution unit 30 instead of the execution unit 30. Each of the instructions is emulated to other instructions, and the execution unit 30 achieves the job. If the instruction is not emulated, the emulator E.M. interprets the instruction to be the branch instruction, and the execution unit 33 achieves the job after recovery from the inactive state.

When the instruction analyzing and distributing unit 20 issues the instruction code representative of the mode change from M2 to M3 to the execution unit 30, the execution unit 30 interprets the instruction code. The execution unit 30 respectively supplies the control signal representative of the mode change from M2 to M3 and the control signal representative of a length of transit time “t” to the mode register 40 and the status information generator 60 at time T2. The status information generator 60 sets the timer for the execution unit 33 to the given length of the transit time, and the mode register 40 supplies the control signal representative of the change of power voltage from V2 to V3 to the electric power and clock controlling unit 50. The electric power and clock controlling unit 50 starts to raise the power voltage supplied to the execution unit 33 at time T2. Although the mode register 40 concurrently supplies the piece of status information D3 to the status information generator 60, the piece of status information D3 is not stored in the status information generator 60 until the transit time “t” is expired. This means that the status information generator 60 still supplies the piece of status information V2 to the instruction analyzing and distributing unit 20. For this reason, the instruction analyzing and distributing unit 20 does not issue any instruction code to the execution unit 33.

When the transit time “t” is expired, the piece of status information D3 is latched by the status information generator 60, and is supplied to the instruction analyzing and distributing unit 20. The power voltage has already reached V3 before expiry of the transit time “t”. When the instruction analyzing and distributing unit 20 finds an instruction code or codes to be executed by the execution unit 33, the instruction analyzing and distributing unit 20 checks the status information to see whether or not the execution unit 33 is presently available for the job at V3. The power voltage in the execution unit 33 has been already raised to V3, and the answer is given affirmative. The instruction analyzing and distributing unit 20 issues the instruction code or codes to the execution unit 33, and the execution unit 33 achieves the job at high speed.

In the super scalar processor described hereinbefore, the mode register 40, status information generator 60 and the electric power and clock controlling unit 50 as a whole constitute a source of power voltage and clock signal.

As will be understood, the instruction analyzing and distributing unit 20 analyzes the instruction codes of each loop so as selectively to assign the jobs represented by the instruction codes to the execution units 30/32/33/34, and changes the job assignment from the execution unit 33 to the execution unit 30 in the presence of the piece of status information representing that the execution unit 33 can not operate at the proper potential level. The time lug, i.e., the length of transit time “t” is automatically defined through the execution of the instruction code representative of the mode change, and the software engineer only inserts the instruction codes for the mode change without consideration of the time lug due to the potential raise. Thus, the super scalar processor according to the present invention makes the load on the software engineer surely reduced.

Although the execution unit 30 is not so fast as the execution unit 33, the super scalar processor does not seriously speed down the data processing. The instructions to be executed by the execution unit 33 is assumed to dynamically take place in a program at 0.1% or less. The instructions are executed by the execution unit 30, and the data processing speed is reduced of the order of 1.5%. However, the power consumption in the execution unit 33 is zero by virtue of the power-off and/or reduction in clock frequency. It is not necessary to set a limit to the jobs achieved in the low power-consumption mode. Although jobs to be achieved at high speed are not reassigned to the execution unit 30, many parts of a program are executable by the execution unit 30, and the power consumption is reduced by easily inserting the instruction code or codes for the mode change in the program.

The emulator E.M. is incorporated in the execution unit of the super scalar processor according to the present invention. This means that it is not necessary to develop any emulation software by the software engineer. The user is free from the cost for developing the emulation program and compiling work.

Second Embodiment

Turning to FIG. 4 of the drawings, another super scalar processor embodying the present invention comprises an instruction buffer unit 11, an instruction analyzing and distributing unit 20, four execution units 30/32/33/34, an electric power and clock controlling unit 50 and a status information generating unit 61. The instruction buffer unit 11, the instruction analyzing and distributing unit 20, four execution units 30/32/33/34 and electric power and clock controlling unit 50 are similar to those of the first embodiment, and description is focused on the status information generating unit 61 for the sake of simplicity.

The status information generator 61 checks the electric power and clock controlling unit 50 to see whether or not the electric power and clock signal are cut off to any one of the execution units 30/32/33/34. The status information generator 61 supplies the instruction analyzing and distributing unit 20 pieces of status information representative of the current status of the supply to the individual execution units 30/32/33/34. When the electric power is presently not supplied to the execution unit 33, the instruction analyzing and distributing unit 20 issues instruction codes to the execution unit 30 instead of the execution unit 33.

In detail, the execution unit 30 produces the control signal representative of the modes to be established in the execution units 30/32/33/34 and the control signal representative of the length of the transit time “t” through the execution of the instruction code for the mode change. The execution unit 30 supplies the control signal representative of the modes to the mode register 40 and the control signal representative of the length of the transit time “t” to the status information generator 61. The control signal representative of the modes is stored in the mode register 40, and the mode register 40 causes the electric power and clock controlling unit 50 to keep or change the power voltage level and the clock frequency supplied to the individual execution units 30/32/33/34 depending upon the modes of operation to be established in the execution units 30/32/33/34. When the electric power and clock controlling unit 50 changes the power voltage level and/or the clock frequency, the status information generator 61 starts the associated timer. Upon expiry of the transit time “t”, the status information generator supplies the piece of status information representative of the new mode, and the instruction analyzing and distributing unit 20 issues the instruction codes to the appropriate execution units 30/32/33/34.

The super scalar processor implementing the second embodiment behaves similar to that of the super scalar processor described hereinbefore, and achieves all the advantages of the present invention.

In the super scalar processor implementing the second embodiment, the mode register 40, the electric power and clock controlling unit 50 and the status information generator 61 as a whole constitute a source of electric power and clock signal.

As will be appreciated from the foregoing description, the super scalar processor according to the present invention analyzes instructions of each loop to see whether or not the instructions are dependent on one another, and is responsive to the status information so as to change the issuance of an instruction or instructions from an execution unit exclusively used for a certain operation to another execution unit, which emulates the instruction or instructions to executable instructions. This results in that the electric power consumption is reduced in the execution unit exclusively used for the operation. This feature is desirable for software engineers, because they are expected to insert an instruction for the mode change in their program sequences. The development cost for the emulation program is not required, and the compile is completed faster than that for the prior art super scalar processor.

The instruction code for the mode change is available for most of the instruction loops of the program except for instruction loops to be executed at extremely high speed. As a result, the power consumption is drastically reduced.

Moreover, the execution unit becomes enable upon expiry of the transit time, and the transit time is automatically given to the status information generator through the execution of the instruction for the mode change. This feature takes a part of load off a software engineer's work.

Although particular embodiments of the present invention have been shown and described, it will be apparent to those skilled in the art that various changes and modifications may be made without departing from the spirit and scope of the present invention.

For example, the mode register 40 may be replaced with a mode controller, which has a data processing capability. In this instance, the instruction codes for the mode change are supplied from the instruction analyzing and distributing unit 20 to the mode controller so that the mode controller per se interprets the instruction codes and determines the transit time “t”.

The status information generator 61 may compare the current values of power voltage level presently supplied to the execution units 30/32/33/34 and the current values of clock frequency supplied to the execution units 30/32/33/34 with reference values so as to produce pieces of status information.

A super scalar processor may have less than four or more than four execution units. More than one execution unit may have the emulator.

What is claimed is:

1. A super scalar processor comprising:
a plurality of execution units supplied with a power voltage and a clock signal for executing instructions in parallel;
an instruction analyzing and distributing unit connected to said plurality of execution units, analyzing instructions to see whether or not said instructions are dependent on one another, and selectively issuing said instructions to said plurality of execution units when said instructions are independent of one another, at least one of said plurality of execution units executing a first sort of instructions so as to produce a control signal representative of values of said power voltage to be respectively supplied to said plurality of execution units and values of the frequency of said clock signal to be respectively supplied to said plurality of execution units; and
a source of power voltage and clock signal connected between said at least one of said plurality of execution units and said plurality of execution units, and responsive to said control signal so as to regulate said power voltage and said clock signal to said values of said power voltage and said values of said clock signal indicated by said control signal, said instruction analyzing and distributing unit assigning an instruction to be executed by one of said plurality of execution units to another of said plurality of execution units when said source of power voltage and clock signal changes at least one of said power voltage and said clock signal from a value to be supplied to said one of said plurality of execution units in enable state to another value different from said value.

2. The super scalar processor as set forth in claim 1, in which said one of said plurality of execution units has a first circuitry exclusively used for a predetermined sort of data processing at high speed, and said another of said plurality of execution units has a second circuitry and an emulator for emulating instructions to be executed by said one of said plurality of execution units to other instructions executable by said second circuitry.

3. The super scalar processor as set forth in claim 2, in which said predetermined sort of data processing is a multiplication so that said emulator converts said instructions for said multiplication to said other instructions.

4. The super scalar processor as set forth in claim 1, in which said source of power voltage and clock signal includes
an electric power and clock signal controlling unit connected to said plurality of execution units and responsive to pieces of status information for regulating said electric power and said frequency of said clock signal to said values of said power voltage and said values of said frequency so as to supply said power voltage and said clock signal to said plurality of execution units,
a mode storing unit connected between said at least one of said plurality of execution units and said electric power and clock signal controlling unit and responsive to a first sub-signal of said control signal for storing said pieces of status information representative of modes where said electric power and said clock signal are specified to said values of said electric power and said values of said frequency of said clock signal, and
a status information supplying unit connected at signal input ports thereof to said at least one of said plurality of execution units and said mode storing unit and at a signal output port thereof to said instruction analyzing and distributing unit for supplying said pieces of status information to said instruction analyzing and distributing unit at a certain timing.

5. The super scalar processor as set forth in claim 4, in which said at least one of said plurality of execution units supplies a second sub-signal of said control signal representative of said certain timing to said status information supplying unit.

6. The super scalar processor as set forth in claim 5, in which said at least one of said plurality of execution units determines said certain timing when said at least one of said plurality of execution units executes said first sort of instructions.

7. The super scalar processor as set forth in claim 6, in which said certain timing is defined as a delay time from the change of said mode represented by said first sub-signal.

8. The super scalar processor as set forth in claim 7, in which said another of said plurality of execution units refuses said instruction if the emulation consumes a time period longer than said delay time.

9. The super scalar processor as set forth in claim 7, in which said instruction represents a job for a transcendental function on floating point numbers

10. The super scalar processor as set forth in claim 7, in which said status information generator has a latch circuit so as to latch said pieces of status information when said delay time is expired.

11. The super scalar processor as set forth in claim 1, in which said source of power voltage and clock signal includes
an electric power and clock signal controlling unit connected to said plurality of execution units and responsive to pieces of status information for regulating said electric power and said frequency of said clock signal to said values of said power voltage and said values of said frequency so as to supply said power voltage and said clock signal to said plurality of execution units,
a mode storing unit connected between said at least one of said plurality of execution units and said electric power and clock signal controlling unit and responsive to a first sub-signal of said control signal for storing said pieces of status information representative of modes where said electric power and said clock signal are specified to said values of said electric power and said values of said frequency of said clock signal, and
a status information supplying unit connected at signal input ports thereof to said at least one of said plurality of execution units and said electric power and clock signal generating unit and at a signal output port thereof to said instruction analyzing and distributing unit for supplying said pieces of status information to said instruction analyzing and distributing unit at a certain timing.

12. The super scalar processor as set forth in claim 11, in which said at least one of said plurality of execution units supplies a second sub-signal of said control signal representative of said certain timing to said status information supplying unit.

13. The super scalar processor as set forth in claim 12, in which said at least one of said plurality of execution units determines said certain timing when said at least one of said plurality of execution units executes said first sort of instructions.

14. The super scalar processor as set forth in claim 13, in which said certain timing is defined as a delay time from the change of said at least one of said power voltage and said frequency of said clock signal.

15. The super scalar processor as set forth in claim 11, in which said status information supplying unit checks said electric power and clock signal generating unit to see whether or not at least one of said electric power and said frequency is changed for any one of said plurality of execution units, and changes the piece of status information when the answer is given affirmative.

16. The super scalar processor as set forth in claim 14, in which said another of said plurality of execution units refuses said instruction if the emulation consumes a time period longer than said delay time.

17. The super scalar processor as set forth in claim 14, in which said instruction represents a job for a transcendental function on floating point numbers

18. The super scalar processor as set forth in claim 14, in which said status information generator has a latch circuit so as to latch said pieces of status information when said delay time is expired.
